(19) United States
(12) Patent Application Publication
(10) Pub. No.: US 2019/0002682 A1
(43) Pub. Date: Jan. 3, 2019

(54) ELASTOMER MATERIAL FOR MEDICAL DEVICES AND ELASTOMER MOLDED BODY FOR MEDICAL DEVICES

(71) Applicant: OLYMPUS CORPORATION, Tokyo (JP)

(72) Inventor: Kazuhito TOMIZUKA, Sagamihara-shi (JP)

(73) Assignee: OLYMPUS CORPORATION, Tokyo (JP)

(21) Appl. No.: 16/124,087

(22) Filed: Sep. 6, 2018

Related U.S. Application Data
(63) Continuation of application No. PCT/JP2017/004737, filed on Feb. 9, 2017.

(30) Foreign Application Priority Data
Mar. 11, 2016 (JP) 2016-048672

(51) Int. Cl. C08L 27/12; C08F 14/26; C08F 14/28; C08F 14/22; C08F 16/24

(52) U.S. Cl. CPC C08L 27/12; C08F 14/26; C08F 14/28; C08F 14/22; C08F 2500/02; C08L 2203/02; C08F 2800/20; C08F 2500/21; C08F 16/24

(57) ABSTRACT

This elastomer material for medical devices contains: a first fluorine-based elastomer that is a ternary copolymer comprising three kinds of monomers A, B and C; and a second fluorine-based elastomer that is a ternary copolymer comprising the monomers A and B and a monomer D which is different from any one of the monomers A, B and C. The monomer C and the monomer D have side chains that have structures different from each other.

### CROSS REFERENCE TO RELATED APPLICATIONS

This application is a continuation application based on a PCT Patent Application No. PCT/JP2017/004737, filed on Feb. 9, 2017, whose priority is claimed on Japanese Patent Application No. 2016-048672, filed on Mar. 11, 2016, the entire contents of which are hereby incorporated by reference.

### BACKGROUND OF THE INVENTION

### Field of the Invention

The present invention relates to elastomeric materials for medical devices and elastomer molded bodies for medical devices.

### Description of the Related Art

For example, an elastomer molded body having resistance in a disinfecting/sterilizing environment is used for a covering member for a medical device which covers the surface of a medical device such as an endoscope. As a material of such an elastomer molded body, fluororubber is known.

For example, Japanese Unexamined Patent Application, First Publication No. H5-300938 discloses a rubber tube for a bending portion an endoscope configured by vulcanizing the compounded kneaded material including 10 to 30 parts by weight of a liquid fluororubber, 0.1 to 1.5 parts by weight of Perhexa (registered trademark) 25B, 0.3 to 4 parts by weight of triallyl isocyanate, and 1 to 10 parts by weight of reinforcing carbon whose average particle is 150 mμ or less, relative to 100 parts by weight of a ternary copolymer of vinylidene fluoride-hexafluoropropylene-tetrafluoroethylene in a weight proportion.

For example, Japanese Unexamined Patent Application, First Publication No. 2005-245517 discloses an elastomer molded body for an endoscope including two or more fluorine-containing elastomers having a crosslinkable crosslinking reactive group.

In Japanese Unexamined Patent Application, First Publication No. 2005-245517, it is proposed to form an elastomer molded body having good durability under severe disinfection/sterilization environment by using a molding material obtained by mixing two or more different fluorine-containing elastomers.

### SUMMARY

An elastomer material for medical devices includes: a first fluorine-based elastomer which is a ternary copolymer having three kinds of monomers A, B and C; and a second fluorine-based elastomer which is a ternary copolymer having the monomers A and B and a monomer D different from any one of the monomers A, B and C, wherein the monomer A is vinylidene fluoride, the monomer B is tetrafluoroethylene, the monomer C is hexafluoropropylene, and the monomer D is perfluoroalkyl vinyl ether.

When total content of the first fluorine-based elastomer and the second fluorine-based elastomer is 100 parts by weight, a crosslinking aid may be contained in an amount of not more than 15 parts by weight and not zero.

When total content of the first fluorine-based elastomer and the second fluorine-based elastomer is 100 parts by weight, a filler may be contained in an amount of not more than 50 parts by weight and not zero.

When total content of the first fluorine-based elastomer and the second fluorine-based elastomer is 100 parts by weight, a third fluorine-based elastomer whose number average molecular weight is 5000 or less and having no crosslinking reactive group may be contained in an amount of not more than 50 parts by weight and not zero.

An elastomer molded body for medical devices includes: a first fluorine-based elastomer which is a ternary copolymer having three kinds of monomers A, B and C; and a second fluorine-based elastomer which is a ternary copolymer having the monomers A and B and a monomer D different from any one of the monomers A, B and C, wherein the monomer A is vinylidene fluoride, the monomer B is tetrafluoroethylene, the monomer C is hexafluoropropylene, and the monomer D is perfluoroalkyl vinyl ether.

When total content of the first fluorine-based elastomer and the second fluorine-based elastomer is 100 parts by weight, a crosslinking aid may be contained in an amount of not more than 15 parts by weight and not zero.

When total content of the first fluorine-based elastomer and the second fluorine-based elastomer is 100 parts by weight, a filler may be contained in an amount of not more than 50 parts by weight and not zero.

When total content of the first fluorine-based elastomer and the second fluorine-based elastomer is 100 parts by weight, a third fluorine-based elastomer whose number average molecular weight is 5000 or less and having no crosslinking reactive group may be contained in an amount of not more than 50 parts by weight and not zero.

### DETAILED DESCRIPTION OF THE PREFERRED EMBODIMENTS

Hereinafter, an elastomeric material for medical devices and an elastomer molded body for medical devices according to an embodiment of the present invention will be described.

The elastomer material for medical devices of the present embodiment includes a first fluorine-based elastomer and a second fluorine-based elastomer.

Four monomers different from each other are represented by monomers A, B, C and D.

The first fluorinated elastomer is a ternary copolymer having three kinds of monomers A, B, and C.

The second fluorinated elastomer is a ternary copolymer having three kinds of monomers A, B, and D.

The monomers C and D have side chains that have structures different from each other. The monomers A and B may have a side chain structure. At least one of the monomers A, B, C and at least one of the monomers A, B, D contains fluorine.

For example, the first fluorinated elastomer is a ternary copolymer having a sequence represented by Aᵢ-Bⱼ-Cₖ. Here, subscripts i, j and k represent the numbers of monomers A, B and C in the first fluorine-based elastomer molecule, respectively. The monomer C may be bonded to any of the monomers A and B.

The second fluorinated elastomer is a ternary copolymer having a sequence represented by A_{i′}-B_{j′}-C_{k′}. Here, subscripts i′, j′ and k′ represent the number of monomers A, B and D in the second fluorine-based elastomer molecule, respectively. However, i′, j′ and k′ may be the same number as i, j and k, respectively, or may be different numbers.

The monomer D may be bonded to any of the monomers A and B.

Examples of monomers that can be used for the monomers A and B include, for example, ethylene, propylene, isoprene, vinylidene fluoride, monofluoroethylene, trifluoroethylene, tetrafluoroethylene, chlorotrifluoroethylene, dichlorodifluoroethylene, trifluorostyrene, pentafluoropropylene, hexafluoropropylene, perfluoroalkyl vinyl ether, perfluoro unsaturated nitrile compound, dialkyl siloxane, and the like.

Examples of the monomers that can be used for the monomers C and D include, for example, monomers having mutually different side chain structures selected from propylene, isoprene, pentafluoropropylene, hexafluoropropylene, perfluoroalkyl vinyl ether, perfluoro unsaturated nitrile compound, dialkyl siloxane and the like.

The elastomer material for medical devices of the present embodiment may contain appropriate additives as necessary. Examples of the additives include, for example, a crosslinking agent, a crosslinking aid, a filler, a plasticizer, a tackifier, a processing aid, a curing agent, an antioxidant, an acid acceptor and the like.

As the crosslinking agent, for example, an organic peroxide may be used.

Examples of the organic peroxides that can be used with the crosslinking agent include, for example, ketone peroxides, diacyl peroxides, dialkyl peroxides, peroxyketals, peroxyesters, percarbonates and the like.

Examples of ketone peroxides include, for example, methyl ethyl ketone peroxide, dimethyl ketone peroxide, and the like.

Examples of the diacyl peroxides include, for example, dibenzoyl peroxide, benzoyl m-methylbenzoyl peroxide, and the like.

Examples of the dialkyl peroxides include, for example, 2,5-dimethyl-2,5-bis (tert-butylperoxy) hexane, 2,5-dimethyl-2,5-bis (tert-butylperoxy) 3-hexyne, and the like.

Examples of the peroxyketals include, for example, 1,1-bis (tert-hexylperoxy) cyclohexane, 1,1-bis (tert-butylperoxy) cyclohexane, and the like.

Examples of the peroxyesters include, for example, 2,5-dimethyl-2,5-bis (benzoylperoxy) 3-hexyne, tert-hexylperoxybenzoate, and the like.

Examples of percarbonates include, for example, diisopropyl peroxydicarbonate, bis (4-tert-butylcyclohexyl) peroxycarbonate, and the like.

Among the organic peroxides exemplified above, 2,5-dimethyl-2,5-di (t-butylperoxy) hexane among diacyl peroxides are particularly preferred.

As the crosslinking aid, an organic compound having co-crosslinking reactivity may be used.

Examples of the organic compound having co-crosslinking reactivity include, for example, an allyl compound, an acrylic compound, and the like.

Examples of allylic compounds include, for example, triallyl isocyanurate, trimethallyl isocyanurate, triallyl cyanurate, and the like.

Examples of the acrylic compound include, for example, trimethylolpropane trimethacrylate, 1,9-nonanediol dimethacrylate, tricyclodecanedimethanol dimethacrylate, polyethylene glycol dimethacrylate, and the like.

Among the crosslinking aids exemplified above, triallyl isocyanurate is particularly preferable.

The crosslinking aid accelerates the crosslinking reaction. The content of the crosslinking aid in the elastomer material for medical devices is set to such an amount that the flexibility required for the elastomer molded body for medical devices is not impaired.

The content of the crosslinking aid is more preferably 15 parts by weight or less, for example, when the total content of the first fluorinated elastomer and the second fluorinated elastomer is 100 parts by weight.

When the content of the crosslinking aid exceeds 15 parts by weight, the crosslinking density becomes excessive, so that the flexibility of the elastomer molded body may be reduced too much.

As the filler, for example, carbon black, an inorganic filler or the like may be used.

Examples of carbon black include, for example, SAF (Super Abrasion Furnace), HAF (High Abrasion Furnace), SRF (Semi-Reinforcing Furnace), MT (Medium Thermal), FEF (Fast Extruding Furnace), and the like. Among them, MT and FEF are particularly preferable. As the carbon black, plural types of carbon black may be used. Examples of the inorganic filler include, for example, silica, barium sulfate, titanium oxide, aluminum oxide, calcium carbonate, calcium silicate, magnesium silicate, aluminum silicate, and the like. As the inorganic filler, plural types of inorganic fillers may be used.

Carbon black and an inorganic filler may be used in combination as a filler used in the elastomer material for medical devices of the present embodiment.

The filler improves the strength and hardness of the molded body, but as the amount of the filler increases, the flexibility of the molded body tends to decrease. The content of the filler in the elastomer material for medical devices is set to such an amount that the flexibility required for the elastomer molded body for medical devices is not impaired.

It is more preferable that the content of the filler in the elastomer material for medical devices is 50 parts by weight or less, for example, when the total content of the first fluorinated elastomer and the second fluorinated elastomer is 100 parts by weight.

When the content of the filler exceeds 50 parts by weight, the flexibility of the elastomer molded body for medical devices may be reduced too much.

As the plasticizer, for example, a third fluorine-based elastomer having a number average molecular weight of 5000 or less and having no crosslinking reactive group may be used.

It is more preferable that the content of the third fluorine-based elastomer in the elastomer material for medical devices is 50 parts by weight or less when the total content of the first fluorinated elastomer and the second fluorinated elastomer is 100 parts by weight.

When the content of the third fluorine-based elastomer exceeds 50 parts by weight, the third fluorine-based elastomer having no crosslinking reactive group inhibits the crosslinking reaction, so that the crosslink density decreases. Therefore, the chemical resistance of the elastomer molded body may be deteriorated.

The elastomer molded body for medical devices according to the present embodiment can be manufactured by performing various well-known moldings using the elastomer material for medical devices of this embodiment as a molding material.

For example, the first fluorine-based elastomer and the second fluorine-based elastomer are masticated together with additives such as a filler compounded as needed. Here, the first fluorine-based elastomer and the second fluorine-based elastomer are main components in the elastomer material for medical devices. For mastication, for example, a kneading machine such as a biaxial roll, a kneader, a Banbury mixer, or the like may be used.

For example, in the case of crosslinking the main agent using a crosslinking agent, kneading may be carried out while adding a crosslinking agent and, if necessary, other additives such as a crosslinking aid and a filler. When a plasticizer is added to the main agent, the addition of the plasticizer may be carried out after all the other additives have been added.

When the mastication is completed, an elastomer material for medical devices, which is a molding material, is prepared.

A known elastomer molding method such as injection molding, extrusion molding, transfer molding, or the like may be used to mold such a molding material.

For example, a forming material to be molded into the shape of an elastomer molded body for medical devices may be filled with a molding material and heated and pressed, and then a forming material may be irradiated with, for example, radiation or the like in order to crosslink the molding material. Further, if necessary, secondary crosslinking may be applied to the molding material, for example, in a hot air flow.

For example, in the case where crosslinking is performed by a crosslinking agent contained in an elastomer material for medical devices, crosslinking molding may be carried out by heating after molding raw material is filled in the same molding die. Thereafter, secondary molding may be applied to the molding material by holding the molding material in a higher temperature oven.

The shape of the elastomer molded body for medical devices is not particularly limited. The shape of the elastomer molded body for medical devices may be appropriately selected according to the use thereof, for example, a sheet shape, a rod shape, a ring shape, various complicated block shapes, and the like.

The application of the elastomer molded body for medical devices of the present embodiment is not particularly limited. The elastomer molded body for medical devices according to the present embodiment may be used in, for example, an outer skin of a bending portion of an endoscope, a bending prevention member of an endoscope, a switch button or an outer cover covering the switch button of an endoscope, an O ring, or the like.

Further, as a medical device using an elastomer molded body for medical devices, it is not limited to an endoscope. The elastomer molded body for medical devices may be used for a medical device such as surgical treatment equipment, for example.

Next, the actions of the elastomeric material for medical devices and the elastomer molded body for medical devices according to the present embodiment will be described.

Both the first fluorine-based elastomer and the second fluorine-based elastomer, which are main components of the elastomer material for medical devices, are ternary copolymers. Each ternary copolymer has a sequence represented by Aᵢ-Bⱼ-Cₖ, A_{i′}-B_{j′}-D_{k′}, respectively.

When the first fluorinated elastomer and the second fluorinated elastomer are mixed, the sites of Aᵢ and Bⱼ are compatible with A_{i′} and B_{j′} composed of the same monomers, respectively. Therefore, the first fluorinated elastomer and the second fluorinated elastomer are rich in compatibility as a whole. It is easy to homogeneously blend the first fluorine-based elastomer and the second fluorine-based elastomer.

However, the first fluorine-based elastomer and the second fluorine-based elastomer have sites of the monomers Cₖ and D_{k′}. The monomers Cₖ and D_{k′} have a side chain structure. The side chain structures of the monomers Cₖ and D_{k′} are sterically hindered. Such steric hindrance has an effect of suppressing crystallization after molding. For this reason, the elastomer molded body containing the first fluorine-based elastomer (the second fluorine-based elastomer) as the main component has excellent cold resistance as compared with the copolymer elastomer molded body not having the side chain structure.

In particular, in the present embodiment, since the monomers C and D have different side chain structures, the sites of Cₖ and D_{k′} have different steric hindrances from each other. For this reason, in the elastomer molded body for medical devices containing the first fluorinated elastomer and the second fluorinated elastomer, crystallization hardly occurs compared with an elastomer molded body including only the first fluorinated elastomer or only the second fluorinated elastomer as the main component. Therefore, the cold resistance is further improved in the elastomer molded body for medical devices of the present embodiment.

When a crosslinking aid is contained in the elastomer material for medical devices of the present embodiment, the crosslinking aid promotes crosslinking. Therefore, the mechanical properties of the elastomer molded body for medical devices are further improved as compared with the case where the crosslinking aid is not contained in the elastomer material for medical devices.

In particular, when the crosslinking aid is triallyl isocyanurate, the trifunctional allyl group of triallyl isocyanurate improves crosslinking efficiency. Therefore, the tear strength of the elastomer molded body for medical devices is further improved.

In addition, since triazine ring is introduced by triallyl isocyanurate, the heat resistance, hydrolysis resistance and weather resistance of the molded elastomer for medical devices are further improved.

When a filler is contained in the elastomer material for medical devices of the present embodiment, since the filler is reinforced, the mechanical properties of the elastomer molded body for medical devices are further improved.

In the case where the third fluorine-containing elastomer is included in the elastomer material for medical devices of the present embodiment, since the third fluorine-based elastomer imparts flexibility to the elastomer molded body for medical devices, the cold resistance of the elastomer molded body is further improved.

As described above, according to the elastomer material for medical devices and the elastomer molded body for medical devices of the present embodiment, it is possible to improve the cold resistance of the elastomer molded body for medical devices.

### EXAMPLE

Hereinafter, examples of the above-described embodiments will be described together with comparative examples. The composition of the elastomer material for medical devices of Examples 1 to 5 and Comparative Examples 1 to 5 is shown in Table 1 below.

TABLE 1

| | MAIN AGENT 1 | | | | | MAIN AGENT 2 | | | | |
|---|---|---|---|---|---|---|---|---|---|---|
| | | CONSTITUTION | | | PARTS | | CONSTITUTION | | | PARTS |
| | | OF MONOMER | | | BY | | OF MONOMER | | | BY |
| | MATERIAL | A | B | C | WEIGHT | MATERIAL | A | B | D | WEIGHT |
| EXAMPLE 1 | #1 | VDF | TFE | HFP | 50 | #2 | VDF | TFE | PAVE | 50 |
| EXAMPLE 2 | #1 | VDF | TFE | HFP | 50 | #3 | VDF | TFE | PMVE | 50 |
| EXAMPLE 3 | #1 | VDF | TFE | HFP | 50 | #2 | VDF | TFE | PAVE | 50 |
| EXAMPLE 4 | #1 | VDF | TFE | HFP | 50 | #2 | VDF | TFE | PAVE | 50 |
| EXAMPLE 5 | #1 | VDF | TFE | HFP | 50 | #2 | VDF | TFE | PAVE | 50 |
| COMPARATIVE | #1 | VDF | TFE | HFP | 50 | #4 | VDF | TFE | HFP | 50 |
| EXAMPLE 1 | | | | | | | | | | |
| COMPARATIVE | #1 | VDF | TFE | HFP | 50 | #5 | VDF | — | HFP | 50 |
| EXAMPLE 2 | | | | | | | | | | |
| COMPARATIVE | #1 | VDF | TFE | HFP | 100 | — | — | — | — | — |
| EXAMPLE 3 | | | | | | | | | | |
| COMPARATIVE | #2 | VDF | TFE | PAVE | 100 | — | — | — | — | — |
| EXAMPLE 4 | | | | | | | | | | |
| COMPARATIVE | #1 | VDF | TFE | HFP | 50 | #2 | VDF | TFE | PAVE | 50 |
| EXAMPLE 5 | | | | | | | | | | |

| | CROSSLINKING | CROSSLINKING | | PLASTICIZING |
|---|---|---|---|---|
| | AGENT | AID | FILLER | AGENT |
| | PARTS BY WEIGHT | PARTS BY WEIGHT | PARTS BY WEIGHT | PARTS BY WEIGHT |
| EXAMPLE 1 | 2.0 | — | — | — |
| EXAMPLE 2 | 2.0 | — | — | — |
| EXAMPLE 3 | 2.0 | 6.0 | — | — |
| EXAMPLE 4 | 2.0 | 6.0 | 30 | — |
| EXAMPLE 5 | 2.0 | 6.0 | 30 | 30 |
| COMPARATIVE | 2.0 | — | — | — |
| EXAMPLE 1 | | | | |
| COMPARATIVE | 2.0 | — | — | — |
| EXAMPLE 2 | | | | |
| COMPARATIVE | 2.0 | — | — | — |
| EXAMPLE 3 | | | | |
| COMPARATIVE | 2.0 | — | — | — |
| EXAMPLE 4 | | | | |
| COMPARATIVE | 2.0 | 6.0 | 30 | 51 |
| EXAMPLE 5 | | | | |

In the “main agent 1” column in the above Table 1, the material of the first fluorinated elastomer, the constitution of the monomer, and the content (parts by weight) are described. In the “main agent 2” column in the above Table 1, the material of the second fluorinated elastomer, the constitution of the monomer, and the content (parts by weight) are described.

However, as described later, the main components 1 and 2 in Comparative Examples 1 to 7 include materials different from the first fluorine-based elastomer and the second fluorine-based elastomer in the elastomer material for medical devices of the above embodiment.

Product names and manufacturers of materials #1 to #5 used for main agents 1 and 2 are shown in the following Table 2. The type of crosslinking agent, crosslinking aid, filler, plasticizer, specific product name, and the like that are used are described below.

TABLE 2

| MATERIAL | PRODUCT NAME | MANUFACTURER |
|---|---|---|
| #1 | DAIEL (REGISTERED | DAIKIN INDUSTRIES, |
| | TRADEMARK) G-912 | LTD |
| #2 | TECNOFLON (REGISTERED | SOLVAY COMPANY |
| | TRADEMARK) FKM PL455 | |
| #3 | VITON (REGISTERED | DUPONT COMPANY |
| | TRADEMARK) GFLT200S | |
| #4 | TECNOFLON (REGISTERED | SOLVAY COMPANY |
| | TRADEMARK) FKM P457 | |
| #5 | DAIEL (REGISTERED | DAIKIN INDUSTRIES, |
| | TRADEMARK) G-701 | LTD |

As shown in Table 2, DAIEL (registered trademark) G-912 (trade name; manufactured by Daikin Industries, Ltd.) was used as the material #1.

Material #1 is a fluororubber made of a ternary copolymer of vinylidene fluoride (VDF), tetrafluorocthylcne (TFE), hexafluoropropylene (HFP) as a monomer. HFP has a —CF₃ group as a side chain.

Tecnoflon (registered trademark) FKM PL 455 (trade name; manufactured by Solvay) was used as the material #2.

Material #2 is a fluororubber composed of a ternary copolymer of VDF, TFE, perfluoroalkyl vinyl ether (PAVE) as a monomer. PAVE has a perfluoroalkyl ether group as a side chain.

For Material #3, Viton (registered trademark) GFLT 200S (trade name; manufactured by Du Pont) was used.

Material #3 is a fluororubber composed of a ternary copolymer of VDF, TFE, perfluoromethyl vinyl ether (PMVE) as a monomer. PMVE has a —O—CF₃ group as a side chain.

Tecnoflon (registered trademark) FKM P 457 (trade name; manufactured by Solvay) was used as the material #4.

Material #4 is a fluororubber composed of a ternary copolymer of VDF, TFE, HFP as a monomer.

As Material #5, Daiel (registered trademark) G-912 (trade name; manufactured by Daikin Industries, Ltd.) was used.

Material #5 is a fluororubber made of a binary copolymer having vinylidene fluoride (VDF), hexafluoropropylene (HFP) as a monomer.

### Example 1

As shown in the above Table 1, the elastomer material for medical devices of Example 1 has the following properties.

Main agent 1 (#1) 50 parts by weight

Main agent 2 (#2) 50 parts by weight

Crosslinking agent 2.0 parts by weight

As the crosslinking agent, 2,5-dimethyl-2,5-bis (tert-butylperoxy) hexane was used as the organic peroxide. Specifically, Perhexa (registered trademark) 25B (trade name; manufactured by NOF CORPORATION) was used.

In Example 1, no crosslinking aid, filler, plasticizer are contained.

### Example 2

The elastomer material for medical devices of Example 2 is different from Example 1 in that the material part #3 that has the same parts by weight is used as the main agent 2 instead of the material #2.

### Example 3

The elastomer material for medical devices of Example 3 is different from Example 1 in that 6.0 parts by weight of a crosslinking aid is contained.

As crosslinking aid, triallyl isocyanurate was used. As a specific material of triallyl isocyanurate, TAIC (registered trademark) (trade name; manufactured by Nippon Kasei Chemical Co., Ltd.) was used.

### Example 4

The elastomer material for medical devices of Example 4 is different from Example 1 in that 30 parts by weight of a filler is contained in addition to 6.0 parts by weight of a crosslinking aid similar to Example 3.

As a filler, silica was used. As a specific material of silica, MiniSeal #5 (trade name; manufactured by U.S. Silica Corporation) was used.

### Example 5

The elastomer material for medical devices of Example 5 is different from Example 1 in that, in addition to 6.0 parts by weight of a crosslinking aid similar to Example 3 and 30 parts by weight of a filler similar to that of Example 4, 30 parts by weight of a plasticizer is contained.

As the plasticizer, a third fluorine-based elastomer having a number average molecular weight of 5000 or less and having no crosslinking reactive group was used.

As a specific material of the third fluorine-based elastomer, DAIEL (registered trademark) G-101 (trade name; manufactured by Daikin Industries, Ltd.) which is a liquid rubber was used.

The number average molecular weight of Daiel (registered trademark) G-101 is 3000.

### Comparative Examples 1 to 4

As shown in Table 1, Comparative Examples 1 to 4 are examples in which the main agent of Example 1 is changed.

In Comparative Example 1, material #4 was used as the main agent 2 instead of material #2. In the materials #1 and #4, since the monomers C and D are both HFP, the monomers C and D do not have mutually different side chain structures.

In Comparative Example 2, a binary copolymer material #5 was used as the main agent 2 instead of the material #2.

In Comparative Example 3, 100 parts by weight of the material #1 used as the main agent 1 in Example 1 was used as the main agent. In Comparative Example 3, the main agent is an example of a fluorocarbon elastomer of one type.

In Comparative Example 4, 100 parts by weight of the material #2 used as the main agent 2 in Example 1 was used as the main agent. In Comparative Example 4, the main agent is an example of a fluorocarbon elastomer of one type.

### Comparative Example 5

As shown in the above Table 1, Comparative Example 5 is an example in which the content of the plasticizer of Example 5 was changed.

Comparative Example 5 is different from Example 5 in that the content of the plasticizer was changed from 30 parts by weight to 51 parts by weight.

The elastomer material for medical devices of Example 1 was weighed so that each of the above-mentioned materials had the above-mentioned blending amount and then kneaded with an open roll to form a compound. The compound was used as a molding material for the elastomer molded body for medical devices of Example 1.

In order to evaluate the elastomer material for medical devices of Example 1, the compound of the elastomer material for medical devices of Example 1 was transfer molded. As a result, an elastomer molded body for medical devices of Example 1 was obtained.

As a mold, a mold for forming a tubular molded body having an outer diameter of 12 mm, a wall thickness of 0.5 mm, and a length of 15 mm was used.

Specifically, the compound was filled in a mold and crosslinking molding at 160° C. for 10 minutes was performed. After this, secondary crosslinking was carried out for 4 hours in an oven at 180° C.

As a result, a tubular elastomer molded body for medical devices having an outer diameter of 12 mm, a wall thickness of 0.5 mm and a length of 15 mm was obtained. The elastomer molded bodys for medical devices were used for evaluation to be described later.

The elastomer materials for medical devices of Examples 2 to 5 and Comparative Examples 1 to 5 were also molded in the same manner as in Example 1. As a result, the elastomer molded bodys for medical devices of Examples 2 to 5 and Comparative Examples 1 to 5 were obtained.

As for the composition in the elastomer molded body for medical devices, when the total content of the main agent is set to 100 parts by weight, the content in the main agent, crosslinking aid, filler, and plasticizer remaining in the elastomer molded body for medical device are the same as the content in the elastomer material for medical devices.

### [Evaluation]

Evaluation of the elastomeric materials for medical devices of the above Examples and Comparative Examples was carried out using the elastomer molded body for tubular medical devices.

Evaluation items and evaluation results are shown in the following Table 3.

TABLE 3

| | | | | BREAKING |
|---|---|---|---|---|
| | COLD | CHEMICAL | COMPREHENSIVE | STRENGTH |
| | RESISTANCE | RESISTANCE | EVALUATION | [MPa] |
| EXAMPLE 1 | ◯ | ◯ | ◯ | 13.2 |
| EXAMPLE 2 | ◯ | ◯ | ◯ | — |
| EXAMPLE 3 | ◯ | ◯ | ◯ | 15.2 |
| EXAMPLE 4 | ◯ | ◯ | ◯ | 17.2 |
| EXAMPLE 5 | ⊚ | ◯ | ◯ | 17.4 |
| COMPARATIVE EXAMPLE 1 | X | ◯ | X | — |
| COMPARATIVE EXAMPLE 2 | X | ◯ | X | — |
| COMPARATIVE EXAMPLE 3 | X | ◯ | X | — |
| COMPARATIVE EXAMPLE 4 | X | ◯ | X | — |
| COMPARATIVE EXAMPLE 5 | ⊚ | X | X | 17.3 |

As shown in Table 3, the cold resistance and the chemical resistance of Examples 1 to 5 and Comparative Examples 1 to 5 were evaluated.

Furthermore, in order to investigate the influence of each additive, as shown in Table 3, breaking strength was measured in Examples 1, 3 to 5 and Comparative Example 5 in which the main agents 1 and 2 were common.

### [Evaluation Method]

The cold resistance was evaluated by using the glass transition temperature (Tg) as an index. The lower the Tg, the wider the temperature range which is the rubber state spreads to the lower temperature side, as a result, cold resistance is excellent as an elastomer material.

Evaluation of cold resistance is very good (expressed as “⊙” (very good) in Table 3) when Tg is less than −40° C., good ((expressed as “∘” (good) in Table 3) when Tg is equal to or more than −40° C. and less than −20° C., and failure (expressed as “x” (no good) in Table 3) when Tg is −20° C. or higher.

Evaluation of chemical resistance was carried out by immersing the elastomer molded body for medical devices in a 3.7% peracetic acid aqueous solution heated to 53° C. for 30 days and then observing the degree of cracking of the elastomer molded body for medical devices. It is good (expressed as “∘” (good) in Table 3) when there is no occurrence of cracks and poor (expressed as “x” (no good) in Table 3) when cracks occur.

The comprehensive evaluation is poor (expressed as “x” (no good) in Table 3) in a case when evaluation of at least one of cold resistance and chemical resistance is poor, and good (expressed as “∘” (good) in Table 3) in other cases.

The breaking strength was measured by a tensile test according to JIS K6251. For use in tensile testing, tensile test pieces according to JIS K6251 were molded with elastomeric materials for medical devices.

It can be said that there is no particular problem as long as the breaking strength of the elastomer molded body for medical devices is 13 MPa or more.

### [Evaluation Results]

As can be seen from the evaluation results described in the above Table 3, in Examples 1 to 4, it was judged that the cold resistance and the chemical resistance were good. Particularly, in Example 5, it was judged that the cold resistance was very good and the chemical resistance was good. Therefore, it was judged that the overall evaluation of Examples 1 to 5 was good.

In contrast, in Comparative Example 1 in which the side chain structures of the main components 1 and 2 are the same and in Comparative Example 2 in which the main agent 2 is the binary copolymer, the cold resistance was judged to be poor, and therefore the overall evaluation was also poor.

Even though the main agent had a side chain structure, in Comparative Examples 3 and 4 comprising one main agent, the cold resistance was poor, so the overall evaluation was poor.

In Comparative Example 5 in which the content of the plasticizer was 51 parts by weight, the cold resistance was determined to be very good, as in Example 5, but because the chemical resistance was poor, the overall evaluation was poor. This is presumably because the added plasticizer does not have a crosslinking reactive group, so that crosslinking reaction was inhibited by containing at least 50 parts by weight. It is considered that the crosslinking reaction was inhibited and the crosslinking density of the molded body was lowered and the chemical resistance was deteriorated.

Although preferred embodiments and examples of the present invention have been described above, the present invention is not limited to such embodiments and examples. Additions, omissions, substitutions, and other changes in the configuration are possible without departing from the spirit of the present invention.

Also, the invention is not limited by the foregoing description, but only by the scope of the appended claims.

What is claimed is:

1. An elastomer material for medical devices comprising:
a first fluorine-based elastomer which is a ternary copolymer having three kinds of monomers A, B and C; and
a second fluorine-based elastomer which is a ternary copolymer having the monomers A and B and a monomer D different from any one of the monomers A, B and C,
wherein the monomer A is vinylidene fluoride, the monomer B is tetrafluoroethylene, the monomer C is hexafluoropropylene, and the monomer D is perfluoroalkyl vinyl ether.

2. The elastomer material for medical devices according to claim 1, wherein,
when total content of the first fluorine-based elastomer and the second fluorine-based elastomer is 100 parts by weight, a crosslinking aid is contained in an amount of not more than 15 parts by weight and not zero.

3. The elastomer material for medical devices according to claim 1, wherein,
when total content of the first fluorine-based elastomer and the second fluorine-based elastomer is 100 parts by weight, a filler is contained in an amount of not more than 50 parts by weight and not zero.

4. The elastomer material for medical devices according to claim 1, wherein,
when total content of the first fluorine-based elastomer and the second fluorine-based elastomer is 100 parts by weight, a third fluorine-based elastomer whose number average molecular weight is 5000 or less and having no crosslinking reactive group is contained in an amount of not more than 50 parts by weight and not zero.

5. An elastomer molded body for medical devices comprising:
a first fluorine-based elastomer which is a ternary copolymer having three kinds of monomers A, B and C; and
a second fluorine-based elastomer which is a ternary copolymer having the monomers A and B and a monomer D different from any one of the monomers A, B and C,
wherein the monomer A is vinylidene fluoride, the monomer B is tetrafluoroethylene, the monomer C is hexafluoropropylene, and the monomer D is perfluoroalkyl vinyl ether.

6. The elastomer molded body for medical devices according to claim 5, wherein,
when total content of the first fluorine-based elastomer and the second fluorine-based elastomer is 100 parts by weight, a crosslinking aid is contained in an amount of not more than 15 parts by weight and not zero.

7. The elastomer molded body for medical devices according to claim 5, wherein,
when total content of the first fluorine-based elastomer and the second fluorine-based elastomer is 100 parts by weight, a filler is contained in an amount of not more than 50 parts by weight and not zero.

8. The elastomer molded body for medical devices according to claim 5, wherein,
when total content of the first fluorine-based elastomer and the second fluorine-based elastomer is 100 parts by weight, a third fluorine-based elastomer whose number average molecular weight is 5000 or less and having no crosslinking reactive group is contained in an amount of not more than 50 parts by weight and not zero.
